(19) United States
(12) Patent Application Publication
(10) Pub. No.: US 2026/0339741 A1
(43) Pub. Date: Oct. 29, 2026

(54) RECEIVE FLOW IMBALANCE CORRECTION

(71) Applicant: Dell Products L.P., Round Rock, TX (US)

(72) Inventors: Dmitry Vladimirovich Krivenok, Leopardstown (IE); Amitai Alkalay, Kadima (IL); Eldad Zinger, Raanana (IL)

(21) Appl. No.: 19/188,435

(22) Filed: Apr. 24, 2025

(51) Int. Cl. G06F 9/50; H04L 47/125; H04L 47/625

(52) U.S. Cl. CPC G06F 9/505; H04L 47/125; H04L 47/6255

(57) ABSTRACT

A technique is directed to balancing workloads among CPU cores in a data storage system. The technique includes distributing flows of network packets among a plurality of receive-side scaling (RSS) contexts such that each of the plurality of RSS contexts receives a respective fraction of the flows. The technique further includes, within an RSS context of the plurality of RSS contexts, forming a fractional group of flows from the respective fraction and assigning the fractional group of flows to a first receive queue of multiple receive queues. The receive queues are shared among the plurality of RSS contexts and assigned to respective CPU cores in the data storage system. The technique still further includes, within the RSS context, reassigning the fractional group of flows to a second receive queue of the receive queues to level workloads of the CPU cores.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Some nodes of a data storage system include one or more network interface controllers (NICs). A NIC is configured to receive network packets containing storage requests from hosts and to sort the network packets into receive queues. The receive queues may be assigned to respective CPU cores, which process the network packets to service the storage requests.

### SUMMARY

Unfortunately, existing processes for assigning network packets to receive queues can create imbalances among the receive queues, which cause corresponding imbalances in workloads handled by the CPU cores. Along these lines, some NICs use a technology known as receive-side scaling (RSS), which directs flows of network packets to receive queues based on mappings specified in an RSS indirection table. A “flow” is a logical grouping of network packets associated with a particular logical connection, such as a TCP (transfer control protocol) connection. Imbalances can arise when the mappings cause the flows to be distributed unevenly among the receive queues.

Certain modifications to an RSS indirection table may reduce these imbalances. For example, it has been noted that one or more mappings in an RSS indirection table may be modified to redirect certain identified flows of network packets from more-filled receive queues to less-filled receive queues, thereby reducing imbalances among those receive queues. It has been further noted that such modifications could be more effective if larger RSS indirection tables were used, as the larger tables would enable flows of network packets to be distributed across a greater number of table entries (mappings), providing finer granularity when redirecting flows to different receive queues. However, RSS indirection tables tend to be fixed in size, such that increasing the size of an indirection table is not generally possible. What is needed, therefore, is a way of redirecting flows of network packets with finer granularity staying with the constraints of existing NIC technology.

The above need is addressed at least in part by an improved technique of managing network-packet flows. The technique includes providing multiple RSS contexts containing respective RSS indirection tables that direct network-packet flows to a common group of receive queues shared among the RSS contexts. The technique further includes distributing network-packet flows among the RSS contexts and directing the flows within the RSS contexts to entries in the respective RSS indirection tables. In this manner, the improved technique leverages the RSS indirection tables in the different RSS contexts to effectively construct a logical RSS indirection table that is larger than any individual indirection table, increasing the total number of RSS indirection table entries used for assigning network-packet flows to the receive queues. Imbalances between the receive queues are then addressed at least in part by modifying mappings of table entries in one or more of the RSS indirection tables to redistribute network-packet flows among the receive queues. Advantageously, this arrangement provides the benefits of a larger RSS indirection table, including finer granularity when redistributing flows among the receive queues, without requiring any changes in NIC technology.

Certain embodiments are directed to a method of balancing workloads among CPU cores in a data storage system. The method includes distributing flows of network packets among a plurality of receive-side scaling (RSS) contexts such that each of the plurality of RSS contexts receives a respective fraction of the flows. The network packets contain storage requests directed to the data storage system. The method further includes, within an RSS context of the plurality of RSS contexts, forming a fractional group of flows from the respective fraction and assigning the fractional group of flows to a first receive queue of multiple receive queues. The receive queues are shared among the plurality of RSS contexts and assigned to respective CPU cores in the data storage system. The method still further includes, within the RSS context, reassigning the fractional group of flows to a second receive queue of the receive queues to level workloads of the CPU cores.

Other embodiments are directed to a computerized apparatus constructed and arranged to perform a method of balancing workloads among CPU cores in a data storage system, such as the method described above. Still other embodiments are directed to a computer program product. The computer program product stores instructions which, when executed on control circuitry of a computerized apparatus, cause the computerized apparatus to perform a method of balancing workloads among CPU cores in a data storage system, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram showing additional features of a receive-side scaling (RSS) context of FIG. 1, according to one or more embodiments.

FIGS. 3a and 3b are block diagrams showing an example rebalancing operation that may be performed by the data storage system of FIG. 1, according to one or more embodiments.

FIG. 4 is a block diagrams showing additional features of an accelerated receive flow steering (aRFS) module of FIG. 1, according to one or more embodiments.

FIG. 5 is a flowchart showing an example method of balancing flows between receive queues that may be performed by the data storage system of FIG. 1, according to one or more embodiments.

FIG. 6 is a flowchart showing an example method of balancing workloads among CPU cores in a data storage system, such as the data storage system of FIG. 1, according to one or more embodiments.

### DETAILED DESCRIPTION

Embodiments of the improved technique will now be described. One should appreciate that such embodiments are provided by way of example to illustrate certain features and principles but are not intended to be limiting.

An improved technique reduces imbalances among receive queues (RXQs) by providing multiple receive-side scaling (RSS) contexts, which contain respective RSS indirection tables that direct network-packet flows to the RXQs. During operation, the network-packet flows are routed first to the particular RSS contexts and then to entries in respective RSS indirection tables of those contexts. In this manner, the multiple RSS indirection tables act as a larger, logical RSS indirection table, effectively increasing the total number of RSS indirection table entries across which to distribute network-packet flows. Imbalances between the RXQs may be addressed by modifying one or more of the RSS indirection tables to redistribute network-packet flows among the RXQs. Advantageously, this arrangement provides the benefits of a larger RSS indirection table including finer granularity when redistributing flows among the RXQs, while staying within the constraints of existing technology.

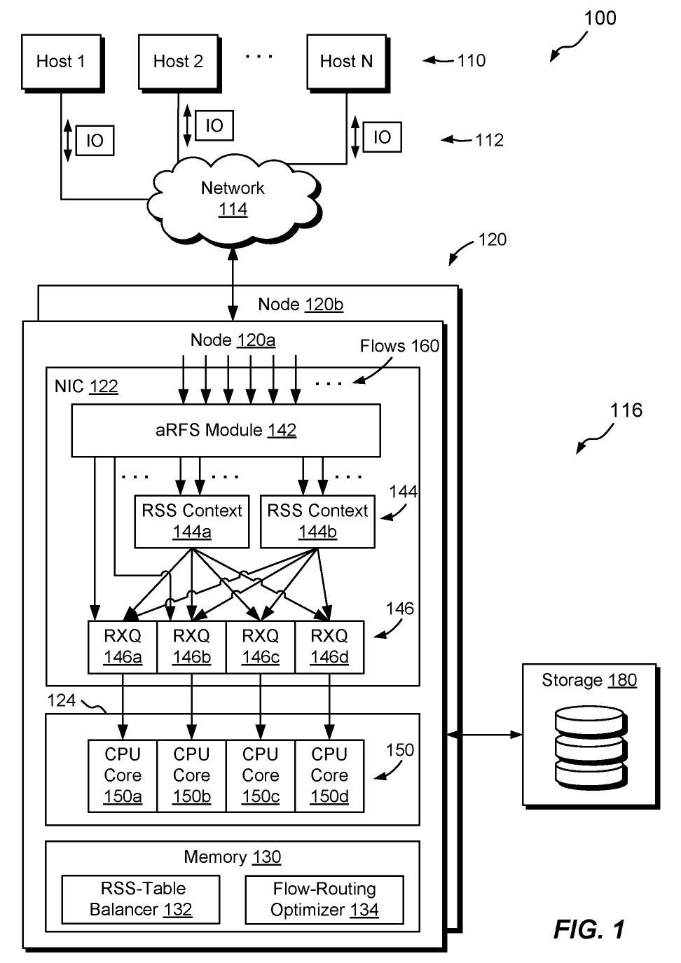

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 180, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host I/O’s.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as iSCSI (Internet small computer system interface), NVMeOF (Nonvolatile Memory Express (NVMe) over Fabrics), NFS (network file system), and CIFS (common Internet file system), for example. As is known, iSCSI and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 180.

The depiction of node 120a is intended to be representative of all nodes 120. As shown, node 120a includes a network interface controller (NIC) 122, a set of processors 124, and memory 130.

The NIC 122 includes various software, hardware, and/or firmware constructs for managing network traffic from the network 114, including an accelerated receive flow steering (aRFS) module 142, receive-side scaling (RSS) contexts 144a and 144b (collectively, RSS contexts 144), and receive queues (RXQs) 146a through 146d (collectively, receive queues 146). These constructs enable the NIC 122 to convert electronic and/or optical signals received over the network 114 to electronic form for use by the node 120a. Here, the signals are provided as network-packet flows 160 (also called simply “flows 160”). These flows 160 represent distinct network connections with the NIC 122 and include network packets carrying host data, e.g., the I/O requests 112 from the hosts 110. Network packets of an individual flow 160 contain common identifying information, such as MAC address, IP address, source port and/or destination port. In some examples, this identifying information is included within a header of the network packets, enabling the NIC 122 to quickly and easily distinguish network packets of different flows 160.

The aRFS module 142 is constructed and arranged to direct the flows 160 to the RSS contexts 144 and/or directly the receive queues 146 via various flow-steering rules. The aRFS module 142 is configured to implement its functions in hardware, and the hardware implementation of the aRFS module 142 supports only a limited number of flow-steering rules at a time.

According to one or more embodiments, the flow-steering rules may be provided in the form of context-routing rules and imbalance-correcting rules. The context-routing rules steer the flows 160 to the RSS contexts 144. In some examples, the aRFS module 142 distributes respective fractions of the flows 160 to each of the RSS contexts 144 via one or more context-routing rules. By contrast, the imbalance-correcting rules steer the flows 160 directly to the receive queues 146, bypassing the RSS contexts 144. In some examples, the imbalance-correcting rules are created and applied after an initial allocation of the flows 160 to the receive queues 146 is established. In this manner, the imbalance-correcting rules may correct any lingering imbalance after the allocation.

The RSS contexts 144 are constructed and arranged to assign the flows 160 to the receive queues 146 based on the identifying information (headers) contained in the network packets of the flows 160. To that end, each of the RSS contexts 144 maintains a respective indirection table having multiple table entries, with each of table entries pointing to a respective one of the receive queues 146. The RSS contexts 144 apply hash-based sorting on packet headers to direct the flows 160 to the table entries, which map the flows 160 to the receive queues 146. It should be appreciated that, due to its random nature, such hash-based sorting may result in imbalances in flow counts between the receive queues 146.

The receive queues 146 are constructed and arranged to receive the flows 160 from the RSS contexts 144, or directly from the aRFS module 142, and to provide network packets from the flows 160 to respective CPU cores 150a through 150d (collectively, CPU cores 150) for processing. In the example shown, the receive queues 146 have one-to-one relationships to the CPU cores 150. However, in some examples, these relationships may be many-to-one or one-to-many.

The constructs of the NIC 122 may be implemented using various technology, e.g., using an Application Specific Integrated Circuit (ASIC), a Field Programmable Gate Array (FPGA), a set of software instructions, and the like. Further, the NIC 122 may be provided in various forms, such as an expansion card, a circuit board, or a chip, for example.

The set of processors 124 includes one or more processing chips and/or assemblies, such as numerous CPUs (central processing units) having the CPU cores 150. The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions, an RSS-table balancer 132 and a flow-routing optimizer 134.

The RSS-table balancer 132 is constructed and arranged to generate updated RSS indirection tables to balance the flows 160 between the receive queues 146. To this end, the RSS-table balancer 132 may access the NIC 122 to detect whether an imbalance exists between the receive queues 146, and to obtain current assignments of the flows 160 to table entries in each of the RSS contexts 144. If an imbalance exists, the RSS-table balancer 132 may generate an updated RSS indirection table that modifies the assignments of the flows 160 to the receive queues 146. For example, the RSS-table balancer 132 may update a table entry that points to a first receive queue 146a to instead point to a second receive queue 146b. Going forward, any of the flows 160 sorted into that table entry will be assigned to the second receive queue 146b rather than the first receive queue 146a.

The flow-routing optimizer 134 is constructed and arranged to adjust aspects of the aRFS module 142 to reroute the flows 160. For example, the flow-routing optimizer 134 may adjust context-routing rules to change a distribution of the flows 160 among the RSS contexts 144. In another example, the flow-routing optimizer 134 may instruct the NIC 122 to change the number of RSS contexts 144 and adjust context-routing rules to distribute the flows 160 over a larger or smaller number of RSS contexts 144. In yet another example, the flow-routing optimizer 134 may instruct the imbalance-correcting rules to steer one or more of the flows 160 directly to one of the receive queues 146, bypassing the RSS contexts 144.

In example operation, the hosts 110 issue I/O requests 112 to the data storage system 116. The node 120 receives the I/O requests 112 at the NIC 122 in the form of network packets, which belong to the flows 160. The NIC 122 processes the flows 160 through the aRFS module 142, which directs the flows 160 to the RSS contexts 144 such that each of the RSS contexts 144 receives a respective fraction of the flows 160 that are received. Within each of the RSS contexts 144, the respective fraction of the flows 160 is sorted into fractional groups of flows corresponding to table entries in an RSS indirection table. Each fractional group of flows contains one or more flows, and typically includes many flows given the typically large number of flows and the limited number of table entries. The table entries point to respective receive queues 146, thereby associating the fractional groups of flows with the receive queues 146.

In further example operation, the RSS-table balancer 132 may detect an imbalance between the receive queues 146. As a result, the RSS-table balancer 132 generates one or more new RSS indirection tables and loads the new RSS indirection tables into the RSS contexts 144. In some examples, the new RSS indirection tables include updated table entries that reassign the fractional groups of flows among the receive queues 146.

As stated previously, each of the multiple RSS contexts 144 maintains a respective RSS indirection table having access to the receive queues 146, which are shared among the RSS contexts 144. The use of multiple RSS contexts 144 enables the NIC 122 to overcome the size limitation of individual RSS indirection tables (e.g., 128 entries). Instead of being limited to just one RSS indirection table, the flows 160 are distributed across the multiple RSS indirection tables, such that the table entries in the RSS indirection tables contain fewer groups of flows on average than they would if one RSS indirection table were used. This arrangement is particularly beneficial when rebalancing, as fewer groups per table entry translates to finer granularity when rearranging the flows 160 among the receive queues 146.

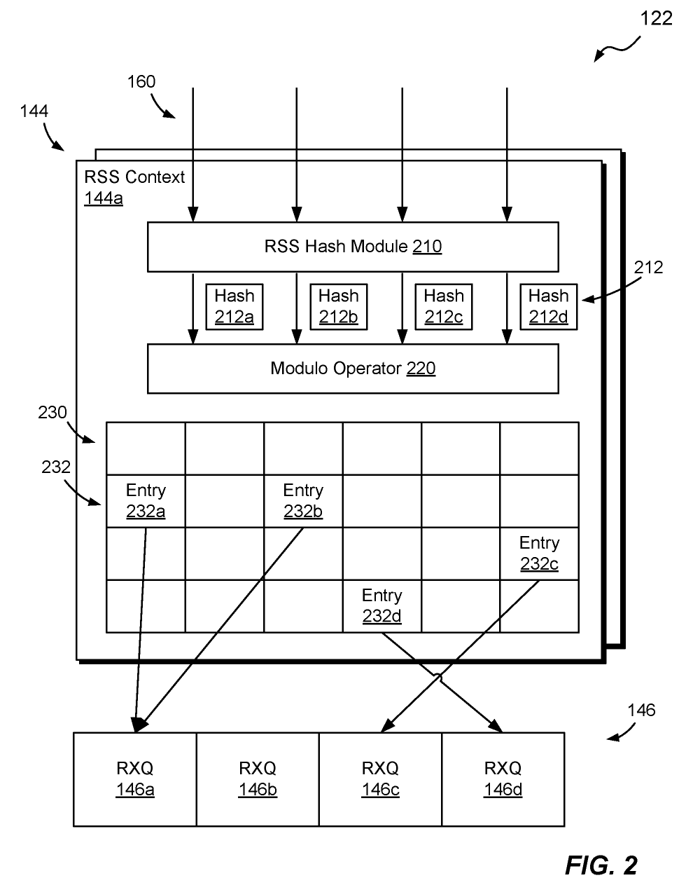

FIG. 2 shows additional details of the RSS contexts 144 in accordance with certain embodiments. The depiction of the RSS context 144a is intended to be representative of all RSS contexts 144. As shown, the RSS context 144a includes an RSS hash module 210, a modulo operator 220, and an RSS indirection table 230.

The RSS hash module 210 is constructed and arranged to generate hash values from the flows 160 entering the RSS context 144a. Along these lines, the RSS hash module 210 may obtain header information from network packets of the flows 160. In some examples, the obtained header information includes only that information from network packet headers which is relevant to specifying the flow to which the network packet belongs. This header information is provided as input to a hash algorithm (e.g., a Toeplitz hash algorithm, an XOR hash algorithm, etc.) to generate the hash values. As the header information for is the same for all network packets belonging to the same flow, all of the network packets belonging to the same flow hash to the same hash value.

The modulo operator 220 is constructed and arranged to perform a modulo operation on the hash values, resulting in respective index values of table entries 232 in the RSS indirection table 230. In the simplified example of FIG. 2, the RSS indirection table 230 includes twenty-four table entries 232. Accordingly, the modulo operator 220 may be configured to provide results ranging from 0 to 23, representing index values of the twenty-four table entries 232. In this manner, modulo operator 220 associates the hash values (and by extension, the flows 160) to the table entries 232. As provided herein, the flows 160 associated with a given table entry 232 are referred to as a fractional group of flows. The word “fractional” in “fractional group” indicates that the number of flows in the group is typically a fraction of what it would be if only one RSS context were used. It is noted that the maximum number of table entries in an RSS indirection table is typically greater than 24, such as 128 entries.

The RSS indirection table 230 contains the table entries 232, including table entries 232a through 232d. Each of the table entries 232 includes a respective pointer to a respective RXQ 146. In some examples, multiple table entries 232 may point to the same receive queue 146.

In example operation, flows 160 enter the RSS context 144a from the aRFS module 142 (FIG. 1). Four flows are shown for purposes of illustration. The RSS hash module 210 receives the flows 160 and acquires header information contained in network packets of the flows 160. The RSS hash module 210 further hashes the header information to generate hash valves 212a through 212d (collectively, hash values 212). The modulo operator 220 receives the hash values 212 and performs a modulo operation on the hash values 212 to obtain index values of table entries 232. In this case, the hash values 212 resolve to index values for the table entries 232a through 232d, respectively, thereby directing the flows 160 to those table entries. The table entries 232a through 232d point to various receive queues 146, with table entries 232a and 232b pointing to receive 146a, the table entry 232c pointing to receive queue 146c, and the table entry 232d pointing to receive queue 146d. In this manner, the entries associate the flows 160 with the receive queues 146.

Similar operation may occur for other RSS contexts 144. Along these lines, the aRFS module 142 may distribute the flows 160 among the RSS contexts 144, thereby enabling the flows 160 to be distributed across a large number of table entries. As a result, the table entries may contain relatively small numbers of the flows 160, providing finer granularity when rebalancing.

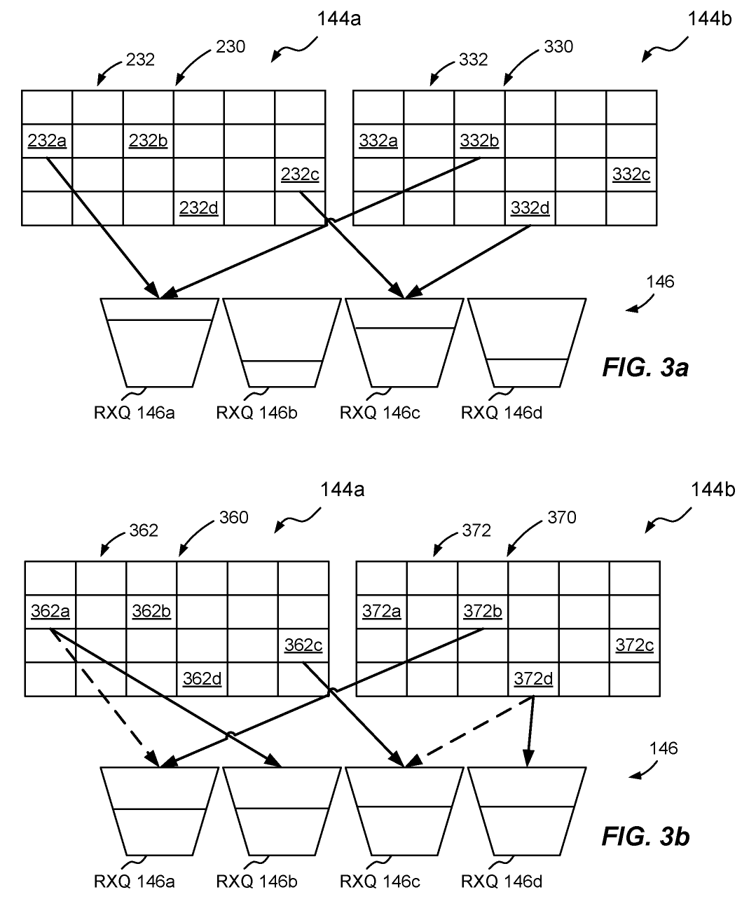

FIGS. 3a and 3b show an example rebalancing operation using multiple RSS indirection tables in accordance with certain embodiments. FIG. 3a shows the RSS indirection table 230 from the RSS context 144a (FIG. 2), as well as a second RSS indirection table 330 from the RSS context 144b. The second RSS indirection table 330 contains table entries 332, including table entries 332a through 332d. The table entries 332 contain respective pointers to the receive queues 146. Some pointers are represented as arrows as shown in FIG. 3a. It should be understood additional pointers are hidden from view for simplicity. In actuality, each of the table entries 232 and 332 contains a respective pointer to a receive queue 146.

FIG. 3b shows a first replacement RSS indirection table 360 and a second replacement RSS indirection table 370. The first replacement RSS indirection table 360 contains table entries 362, including table entries 362a through 362d. Similarly, the second replacement RSS indirection table 370 contains table entries 372, including table entries 372a through 372d. The replacement RSS indirection tables 360 and 370 contain pointers to the receive queues 146. Similar to FIG. 3a, only some of the pointers in FIG. 3b are shown, with additional pointers being hidden for simplicity.

During example operation and with reference to FIG. 3a, the aRFS module 142 (FIG. 1) assigns a respective fraction of the flows 160 to each of the RSS contexts 144a and 144b. Within each of the RSS contexts 144, the flows 160 from the respective fraction are grouped into the table entries 232 or 332, which contain pointers to the receive queues 146. Based on the pointers, the groups of the flows 160 are mapped to the receive queues 146. As shown, the groups of the flows 160 in the table entries 232a and 332b are assigned to the receive queue 146a, and the groups of the flows 160 in the table entries 232c and 332d are assigned to the receive queue 146c. As shown, the receive queues 146 are imbalanced, with receive queues 146a and 146c containing an above-average number of the flows 160, and the receive queues 146b and 146d containing a below-average number of the flows 160.

Based on the imbalance, the RSS-table balancer 132 (FIG. 1) generates the replacement RSS indirection 360 and 370 (FIG. 3b), which include updated table entries 362a and 372d. As a result, groups of the flows 160 that map to these entries are reassigned, thereby reducing differences between the receive queues 146. The arrows with dashed lines in FIG. 3b indicate prior assignments of the flows 160, while the arrows with solid lines indicate current assignments of the flows 160. Under the current assignments, the number of the flows 160 may be balanced between the receive queues 146.

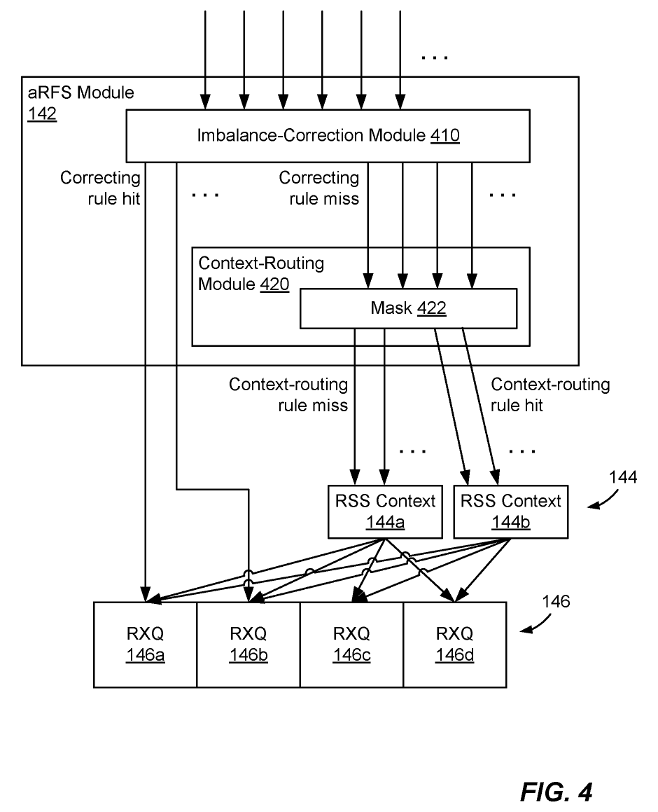

FIG. 4 shows additional details of the aRFS module 142 (FIG. 1) in accordance with certain embodiments. As shown, the aRFS module includes an imbalance-correction module 410 and a context-routing module 420.

The imbalance-correction module 410 is constructed and arranged to apply imbalance-correcting rules to steer one or more of the flows 160 directly to the receive queues 146, bypassing the RSS contexts 144. In some examples, the imbalance-correction module 410 monitors identifying metadata (e.g., headers) contained within network packets of the flows 160 and compares the identifying metadata to triggers for applying imbalance-correcting rules. If a flow 160 triggers an imbalance-correcting rule, then the imbalance-correction module 410 directs the flow 160 to a receive queue 146 as indicated by the rule. In this manner, the flow 160 may bypass the RSS contexts 144. If a flow 160 does not trigger an imbalance-correcting rule, then the imbalance-correction module 410 directs the flow 160 to the context-routing module 420 for further processing.

The context-routing module 420 is constructed and arranged to direct the flows 160 to the RSS contexts 144 based on a set of context-routing rules. To that end, the context-routing module 420 applies a mask 422 to identifying metadata (e.g., headers) contained within network packets of the flows 160. A result of the masking is compared to triggers for any context-routing rules currently active. If a flow 160 triggers a context-routing rule, then the context-routing module 420 routes the flow 160 to an RSS context 144 as indicated by the rule. If a flow 160 does not trigger a context-routing rule, then the context-routing module 420 directs the flow 160 to a default RSS context, which in this case is the RSS context 144a.

Masking the identifying metadata reveals unmasked bits. In some examples, the number of unmasked bits is based on the total number of RSS contexts 144. For example, in an arrangement with four RSS contexts 144, the mask can reveal two unmasked bits, providing a total of four possible states: 00, 01, 10, and 11. Each state may be associated with a different one of the RSS contexts 144. In this manner, the context-routing module 420 may quickly and efficiently distribute the flows 160 to the RSS contexts 144.

The unmasked bits may be contiguous or non-contiguous within the headers. Along these lines, in the above example with four RSS contexts 144, the mask 422 may be applied to headers having 16 bits, with any combination of two bits being unmasked. However, it should be appreciated that certain bits may provide better candidates for masking, such as those which vary more among headers of different flows 160.

In some examples, the context-routing module 420 does not require a context-routing rule for the default RSS context. Instead, the context-routing module 420 directs a flow 160 to the default RSS context if the flow 160 did not trigger a context-routing rule (i.e., a “rule miss”). In this manner, the total number of flow-steering rules may be reduced.

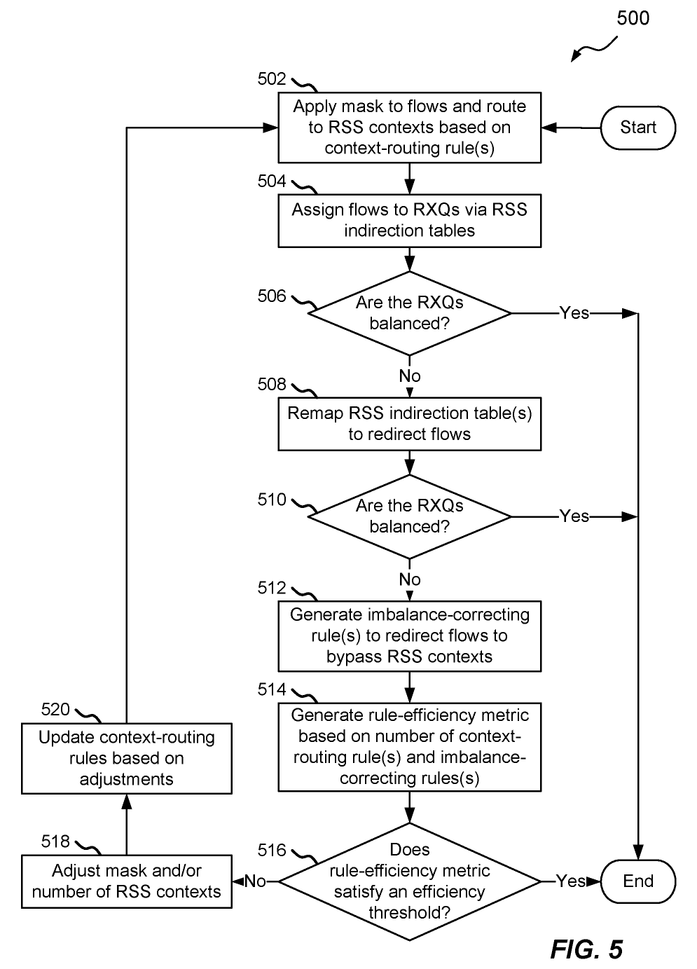

FIG. 5 shows an example method 500 for balancing the flows 160 between the receive queues 146 in accordance with certain embodiments. The method 500 may be performed, for example, when one or more new connections to the NIC 122 are established.

At 502, the context-routing module 420 (FIG. 4) applies the mask 422 to the flows 160 and distributes the flows 160 among the RSS contexts 144 based on a result of the masking.

At 504, within each of the RSS contexts 144, the flows 160 are assigned to the receive queues 146 based on the flows 160 being sorted among table entries in a respective RSS indirection table.

At 506, the RSS-table balancer 132 (FIG. 1) checks the balance of the flows 160 within the receive queues 146. If the flows 160 are sufficiently balanced, then no imbalance correction is necessary and the method 500 ends. However, if there is an imbalance between receive queues 146, then the method 500 proceeds to 508. In some examples, the RSS-table balancer 132 obtains the numbers of flows 160 in the receive queues 146 and detects the imbalance based on the numbers of flows 160.

At 508, the RSS-table balancer 132 generates one or more updated RSS indirection tables and loads each of the updated RSS indirection tables into the respective RSS context 144. These updated RSS indirection tables include updated table entries, which remap the flows 160 to the receive queues 146 based on the imbalance between the flows 160 in the receive queues 146. In this manner, the balance of the flows 160 is adjusted.

At 510, after adjusting the balance of the flows 160 via the updated RSS indirection tables, the flow-routing optimizer 134 (FIG. 1) checks the receive queues 146 for any lingering imbalance. If the flows 160 are sufficiently balanced, then no further imbalance correction is necessary and the method 500 ends. However, if there is an imbalance between receive queues 146, then the method 500 proceeds to 512. In some examples, the flow-routing optimizer 134 obtains the numbers of flows 160 in the receive queues 146 and detect the imbalance based on the numbers of flows 160.

At 512, after detecting the imbalance, the flow-routing optimizer 134 generates one or more imbalance-correcting rules configured to redirect respective flows 160 to the receive queues 146, bypassing the RSS contexts 144. In this manner, the imbalance may be further reduced.

At 514, the flow-routing optimizer 134 generates a rule-efficiency metric based on the number of context-routing rules and the number of imbalance-correcting rules, if any. In some examples, the rule-efficiency metric is a sum of the number of context-routing rules and the number of imbalance-correcting rules.

At 516, the rule-efficiency metric is compared to a predetermined efficiency threshold. If the rule-efficiency metric satisfies the predetermined efficiency threshold, then no further imbalance correction is necessary and the method 500 ends. However, if the rule-efficiency metric fails to satisfies the predetermined efficiency threshold, then the method 500 proceeds to 518.

At 518, the flow-routing optimizer 134 adjusts the mask 422 and/or the number of RSS contexts 144. For example, the flow-routing optimizer 134 may generate a second mask to apply in place of the mask 422. The second mask may provide different unmasked bits from those provided by the mask 422. As another example, the flow-routing optimizer 134 may instruct the NIC 122 to increase or decrease the number of RSS contexts 144.

At 520, the flow-routing optimizer 134 modifies the context-routing rules based on the adjustments in 518. For example, if the mask 422 has been changed to a second mask providing different unmasked bits, the flow-routing optimizer 134 may modify the context-routing rules to trigger based on the different unmasked bits. If the number of RSS contexts 144 has increased, then the flow-routing optimizer 134 may implement one or more additional context-routing rules to direct the flows 160 to any new RSS contexts 144. Similarly, if the number of RSS contexts 144 has decreased, then the flow-routing optimizer 134 may remove one or more context-routing rules to no longer direct the flows 160 to any removed RSS contexts 144. After 520, the method 500 proceeds back to 502 and continues based on the adjusted mask and/or number of RSS contexts 144.

Advantageously, the method 500 enables the data storage system 116 to incrementally improve the assignment of the flows 160 to the receive queues 146. In some examples, the method 500 may continue indefinitely (e.g., in the background) or intermittently.

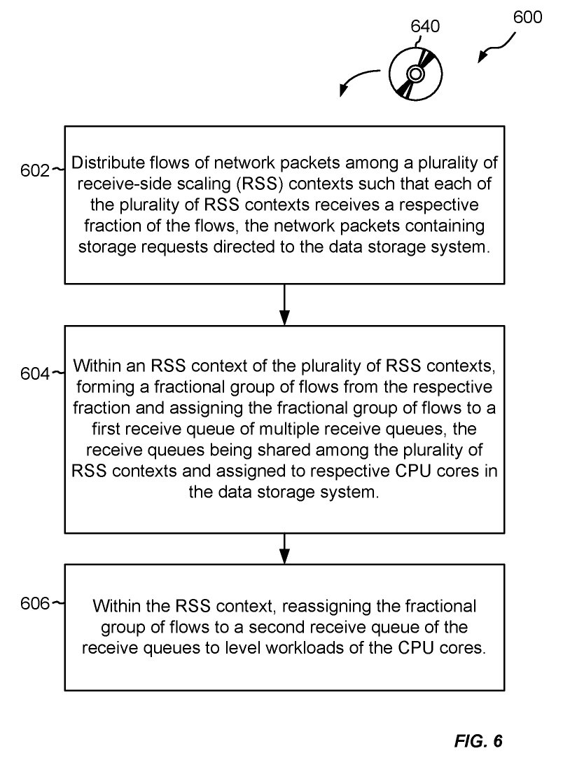

FIG. 6 shows an example method 600 that may be carried out in connection with the environment 100. The method 600 is typically performed, for example, by the software, hardware, and/or firmware constructs described in connection with FIGS. 1, 2, and 4, which reside in the NIC 122 and in the memory 130 of a node 120. The various acts of method 600 may be ordered in any suitable way. Accordingly, embodiments may be constructed in which acts are performed in orders different from that illustrated, which may include performing some acts simultaneously.

At 602, the aRFS module 142 distributes flows 160 of network packets among a plurality of receive-side scaling (RSS) contexts 144 such that each of the plurality of RSS contexts 144 receives a respective fraction of the flows 160. The network packets contain storage requests 112 directed to the data storage system 116.

At 604, within an RSS context of the plurality of RSS contexts 144, a fractional group of flows is formed from the respective fraction. Further, the fractional group of flows is assigned to a first receive queue of multiple receive queues 146. The receive queues 146 are shared among the plurality of RSS contexts 144 and assigned to respective CPU cores 150 in the data storage system 116. For example, as shown in FIG. 2, the fraction of the flows 160 directed to RSS context 144a are processed by the RSS hash module 210 and modulo operator 220 to direct a group of the flows 160 to a table entry 232a in the RSS indirection table 230. The table entry 232a maps the group of the flows 160 to the receive queue 146a.

At 606, within the RSS context, the fractional group of flows are reassigned to a second receive queue of the receive queues 146 to level workloads of the CPU cores 150. For example, as shown in FIGS. 3a and 3b, the RSS indirection table 230 may be replaced by the replacement RSS indirection table 360, with the group of flows originally directed to the table entry 232a (FIG. 3a) now being directed to the table entry 362a (FIG. 3b). The table entry 362a redirects the group of flows to the second receive queue 146b. In this manner, workloads between the CPU cores 150 may be balanced.

An improved technique is directed to reducing imbalances between receive queues (RXQs) by providing multiple receive-side scaling (RSS) contexts, which contain respective RSS indirection tables (RSS-ITs) that direct network-packet flows to a common group of RXQs. During operation, the network-packet flows are routed first to the particular RSS-ITs and then to entries in the particular RSS-ITs. In this manner, the multiple RSS-ITs act as a single, larger RSS-IT, effectively increasing the total number of RSS-IT entries for distributing network-packet flows. Imbalances between the RXQs may be addressed by modifying one or more of the RSS-ITs to redistribute network-packet flows among the RXQs. Advantageously, this arrangement provides the benefits of a larger RSS-IT including finer granularity when redistributing flows among the RXQs.

Having described certain embodiments, numerous alternative embodiments or variations can be made. For example, the example method 500 (FIG. 5) as described above includes the step 516 of comparing a rule-efficiency metric to a predetermined efficiency threshold before adjusting a mask or a number of RSS contexts. As an alternative to the step 516, the data storage system 116 may simply iterate through multiple (e.g., all) combinations of masks and/or RSS contexts and select the best combination at the end.

Also, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 640 in FIG. 6). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of balancing workloads among CPU cores in a data storage system, the method comprising:
distributing flows of network packets among a plurality of receive-side scaling (RSS) contexts such that each of the plurality of RSS contexts receives a respective fraction of the flows, the network packets containing storage requests directed to the data storage system;
within an RSS context of the plurality of RSS contexts, forming a fractional group of flows from the respective fraction and assigning the fractional group of flows to a first receive queue of multiple receive queues, the receive queues being shared among the plurality of RSS contexts and assigned to respective CPU cores in the data storage system; and
within the RSS context, reassigning the fractional group of flows to a second receive queue of the receive queues to level workloads of the CPU cores.

2. The method of claim 1,
wherein the RSS context includes an RSS indirection table,
wherein forming the fractional group of flows includes directing a set of flows of the respective fraction of the flows to a table entry of the RSS indirection table, and
wherein the table entry maps the set of flows to the first receive queue.

3. The method of claim 2, further comprising, prior to reassigning the fractional group of flows to the second receive queue, detecting an imbalance between respective numbers of flows assigned to the first and second receive queues,
wherein reassigning the fractional group of flows to the second receive queue includes modifying the table entry based on the imbalance to remap the set of flows to the second receive queue .

4. The method of claim 1, wherein distributing the flows among the plurality of RSS contexts includes:
masking a portion of metadata of the flows; and
directing the flows to the RSS contexts based on a result of the masking.

5. The method of claim 4,
wherein masking the portion of metadata produces a set of unmasked bits of the portion of metadata, and
wherein directing the flows to the RSS contexts is based on values of the unmasked bits.

6. The method of claim 4,
wherein masking the portion of metadata includes applying a first mask to the metadata, and
wherein the method further comprises:
after reassigning the fractional group of flows, detecting an imbalance of flows assigned to the receive queues;
based on the imbalance, applying a second mask to the metadata, the second mask being different from the first mask; and
distributing flows of newly arriving network packets among the RSS contexts based on the second mask.

7. The method of claim 1, further comprising:
after reassigning multiple fractional groups of flows among the receive queues to decrease an initial imbalance of flows assigned to the receive queues, detecting a remaining imbalance of flows assigned to the receive queues; and
based on detecting the remaining imbalance, applying an imbalance-correcting rule to reroute a flow that was previously directed to one of the RSS contexts to one of the receive queues without distributing the flow to any RSS context.

8. The method of claim 1,
wherein distributing the flows among the plurality of RSS contexts includes applying a set of context-routing rules to route the flows to RSS contexts of the plurality of RSS contexts, and
wherein the method further comprises:
after reassigning multiple fractional groups of flows among the receive queues to decrease an initial imbalance of flows assigned to the receive queues, generating a set of imbalance-correcting rules configured to reroute a portion of the flows to receive queues without distributing the portion of flows to any RSS context;
generating an efficiency metric based on the set of context-routing rules and the set of imbalance-correcting rules; and
based on a comparison between the efficiency metric and a predetermined efficiency threshold, performing a set of rebalancing operations that reduces at least one of the set of context-routing rules or the set of imbalance-correcting rules.

9. The method of claim 1, further comprising receiving the flows from a set of host computers communicatively coupled with the data storage system.

10. A computerized apparatus, comprising control circuitry that includes a set of processors coupled to memory, the control circuitry constructed and arranged to:
distribute flows of network packets among a plurality of receive-side scaling (RSS) contexts such that each of the plurality of RSS contexts receives a respective fraction of the flows, the network packets containing storage requests directed to the data storage system;
within an RSS context of the plurality of RSS contexts, form a fractional group of flows from the respective fraction and assign the fractional group of flows to a first receive queue of multiple receive queues, the receive queues being shared among the plurality of RSS contexts and assigned to respective CPU cores in the data storage system; and
within the RSS context, reassign the fractional group of flows to a second receive queue of the receive queues to level workloads of the CPU cores.

11. A computer program product including a set of non-transitory, computer-readable media having instructions which, when executed by control circuitry of a computerized apparatus, cause the computerized apparatus to perform a method of balancing workloads among CPU cores in a data storage system, the method comprising:
distributing flows of network packets among a plurality of receive-side scaling (RSS) contexts such that each of the plurality of RSS contexts receives a respective fraction of the flows, the network packets containing storage requests directed to the data storage system;
within an RSS context of the plurality of RSS contexts, forming a fractional group of flows from the respective fraction and assigning the fractional group of flows to a first receive queue of multiple receive queues, the receive queues being shared among the plurality of RSS contexts and assigned to respective CPU cores in the data storage system; and
within the RSS context, reassigning the fractional group of flows to a second receive queue of the receive queues to level workloads of the CPU cores.

12. The computer program product of claim 11,
wherein the RSS context includes an RSS indirection table,
wherein forming the fractional group of flows includes directing a set of flows of the respective fraction of the flows to a table entry of the RSS indirection table, and
wherein the table entry maps the set of flows to the first receive queue.

13. The computer program product of claim 12,
wherein the method further includes, prior to reassigning the fractional group of flows to the second receive queue, detecting an imbalance between respective numbers of flows assigned to the first and second receive queues, and
wherein reassigning the fractional group of flows to the second receive queue includes modifying the table entry based on the imbalance to remap the set of flows to the second receive queue.

14. The computer program product of claim 11, wherein distributing the flows among the plurality of RSS contexts includes:
masking a portion of metadata of the flows; and
directing the flows to the RSS contexts based on a result of the masking.

15. The computer program product of claim 14,
wherein masking the portion of metadata produces a set of unmasked bits of the portion of metadata, and
wherein directing the flows to the RSS contexts is based on values of the unmasked bits.

16. The computer program product of claim 14,
wherein masking the portion of metadata includes applying a first mask to the metadata, and
wherein the method further includes:
after reassigning the fractional group of flows, detecting an imbalance of flows assigned to the receive queues;
based on the imbalance, applying a second mask to the metadata, the second mask being different from the first mask; and
distributing flows of newly arriving network packets among the RSS contexts based on the second mask.

17. The computer program product of claim 11, wherein the method further comprises:
after reassigning multiple fractional groups of flows among the receive queues to decrease an initial imbalance of flows assigned to the receive queues, detecting a remaining imbalance of flows assigned to the receive queues; and
based on detecting the remaining imbalance, applying an imbalance-correcting rule to reroute a flow that was previously directed to one of the RSS contexts to one of the receive queues without distributing the flow to any RSS context.

18. The computer program product of claim 11,
wherein distributing the flows among the plurality of RSS contexts includes applying a set of context-routing rules to route the flows to RSS contexts of the plurality of RSS contexts, and
wherein the method further includes:
after reassigning multiple fractional groups of flows among the receive queues to decrease an initial imbalance of flows assigned to the receive queues, generating a set of imbalance-correcting rules configured to reroute a portion of the flows to receive queues without distributing the portion of flows to any RSS context;
generating an efficiency metric based on the set of context-routing rules and the set of imbalance-correcting rules; and
based on a comparison between the efficiency metric and a predetermined efficiency threshold, performing a set of rebalancing operations that reduces at least one of the set of context-routing rules or the set of imbalance-correcting rules.

19. The computer program product of claim 11, wherein the method further includes receiving the flows from a set of host computers communicatively coupled with the data storage system.
